(19) United States
(12) Patent Application Publication
(10) Pub. No.: US 2020/0041135 A1
(43) Pub. Date: Feb. 6, 2020

(54) Slim Profile Spray Nozzle for Cooking Appliance

(71) Applicant: Alto-Shaam, Inc., Menomonee Falls, WI (US)

(72) Inventor: Andrew Szczepaniak, Hartland, WI (US)

(21) Appl. No.: 16/052,110

(22) Filed: Aug. 1, 2018

(51) Int. Cl. F24C 14/00; B05B 1/14

(52) U.S. Cl. CPC F24C 14/005; B05B 1/14

(57) ABSTRACT

A cooking oven is provided having a cleaning system with a spray nozzle that leverages the kinetic energy of the cleaning fluid entering the nozzle to aid in the dispersion of this cleaning fluid. This is done by conducting that fluid in a circular path to preserve its kinetic energy as it circulates around the nozzle and is discharged tangentially. Desirably, the circulation of the cleaning fluid is in a horizontal axis so as to minimize the nozzle height.

### CROSS REFERENCE TO RELATED APPLICATION

### BACKGROUND OF THE INVENTION

The present invention relates to cooking appliances for the preparation of food, and in particular, to cleaning systems for cooking ovens having a nozzle for dispersion of cleaning fluids to a cooking chamber.

Combination ovens provide the ability to cook foods using steam, hot-air convection, or both steam and convection. A motor driven fan is used to circulate air within a cooking chamber past electrical heating elements or gas heat exchange tubes to perform the convection functionality. To produce steam within the cooking chamber, a water line feeds water into the cooking chamber near the heating elements to vaporize the water creating steam.

Cleaning of grease that builds up inside the cooking chamber can be a time-consuming process. This has led to the development of ovens with automated cleaning systems that initiate automatically after a cooking schedule, after a predetermined number of cooking cycles, or when a cleaning cycle is initiated by the user. These automated cleaning oven systems utilize built-in spray systems distributing a cleaning fluid comprising water and detergent that do not require the user to open the oven door or access the cooking chamber for cleaning.

In order to clean the entirety of the cooking chamber, the automated cleaning systems typically utilize a spray-type nozzle positioned at the very top of the oven cavity to recirculate the cleaning fluid through the nozzle to spray in multiple directions to the sidewalls of the cooking chamber. For example, US patent application publication 2008/0223357, assigned to the assignee of the present invention and hereby incorporated by reference, describes a downward spray-type nozzle having downward ports used in conjunction with a fluid diverter disk positioned below the nozzle to catch and divert the spray of cleaning fluid through vertically extending holes in multiple directions toward the sidewalls of the cooking chamber.

Desirably, the spray nozzle has large openings to prevent the openings from being prematurely clogged with debris and the like, however, larger holes can adversely affect the velocity of the discharge water reducing its dispersion and effectiveness in cleaning.

### SUMMARY OF THE INVENTION

The present invention provides a spray nozzle that leverages the kinetic energy of the cleaning fluid entering the nozzle to aid in the dispersion of this cleaning fluid. This is done by conducting that fluid in a circular path to preserve its kinetic energy as it circulates around the nozzle and is discharged tangentially. Desirably, the circulation of the cleaning fluid is in a horizontal axis so as to minimize the nozzle height.

Therefore, the present invention provides a slim profile, circular nozzle having a side entrance permitting distribution of cleaning fluid in a wide range of downward angles. The present invention provides for the conversion of kinetic energy into circular flow for quick deflection of fluids into a multi-directional spray.

In one embodiment, the invention provides a cooking oven including an oven housing providing a cooking cavity having sidewalls flanking a cooking volume, the cooking volume accessible through an oven door when the oven door is in an open position and sealed by the oven door when the oven door is in a closed position; a heater communicating with the cooking cavity to heat air of the cooking cavity; and a nozzle having an inlet for receiving a stream of water and providing a curved diverter wall for directing the stream of water to one or more outlets providing sub streams in different directions.

It is thus a feature of at least one embodiment of the invention to preserve the kinetic energy of the water to assist with ejecting the stream of water farther with greater pressure.

The stream may meet the curved diverter wall along a tangent of the curved diverter wall.

It is thus a feature of at least one embodiment of the invention to minimize the energy wasting turbulence that occurs when a stream of water hits a wall.

The stream of water may be directed horizontally and the curved diverter wall may curve in a horizontal plane. The curved diverter wall may be substantially circular.

It is thus a feature of at least one embodiment of the invention to minimize the nozzle height in order to maximize the cleaning of the top of the cooking cavity.

The curved diverter wall may abut a bottom wall providing openings directing sub streams of water downward and tangentially to the curved diverter wall. The outlets may be in a horizontal plane below the curved diverter wall.

It is thus a feature of at least one embodiment of the invention to enlist the force of gravity to move the water in multiple spray directions.

The outlets may be slots extending radially from an axis of the curved diverter wall.

It is thus a feature of at least one embodiment of the invention to allow for large sized slots that will not clog with food debris.

The multiple outlets may comprise of four outlets. The multiple outlets may provide sub streams in orthogonal directions.

It is thus a feature of at least one embodiment of the invention to encourage wide area cleaning of the cooking cavity.

The inlet may further comprise a cylindrical tube extending into the nozzle. The inlet may open into the nozzle along a tangent of the curved diverter wall.

It is thus a feature of at least one embodiment of the invention to allow the nozzle to be adaptable to preinstalled oven hose systems.

The oven may further comprise a hose extending between a fresh water source and the nozzle. The hose may extend along a ceiling of the cooking cavity and the nozzle may be positioned substantially centered within a ceiling of the cooking cavity.

In another embodiment, the invention provides a method of cleaning a cooking oven of a type having an oven housing providing a cooking cavity having sidewalls flanking a cooking volume, the cooking volume accessible through an oven door when the oven door is in an open position and sealed by the oven door when the oven door is in a closed position; a heater communicating with the cooking cavity to heat air of the cooking cavity; a nozzle having an inlet for receiving a stream of water and providing a curved diverter wall for directing the stream of water to multiple outlets providing sub streams in different directions; an inlet valve receiving water from a source of pressurized water and communicating water to the nozzle; and an electronic computer communicating with the liquid inlet valve. The method comprising the steps of executing a stored program on the electronic computer to actuate the inlet valve so provide pressurized water flow into the nozzle for a cleaning operation.

These particular objects and advantages may apply to only some embodiments falling within the claims and thus do not define the scope of the invention.

### BRIEF DESCRIPTION OF THE DRAWINGS

FIG. 1 is a perspective view of a combination oven incorporating a cleaning assembly having a nozzle according to the present invention;

FIG. 2 is a perspective view of the nozzle used with the cleaning assembly illustrated in FIG. 1 showing a cutaway exposing a fluid flow path from inside the nozzle housing to outside the nozzle housing; and

FIG. 3 is a bottom plan view of the nozzle illustrated in FIG. 2 showing downward exit ports of the nozzle housing.

### DETAILED DESCRIPTION OF THE PREFERRED EMBODIMENT

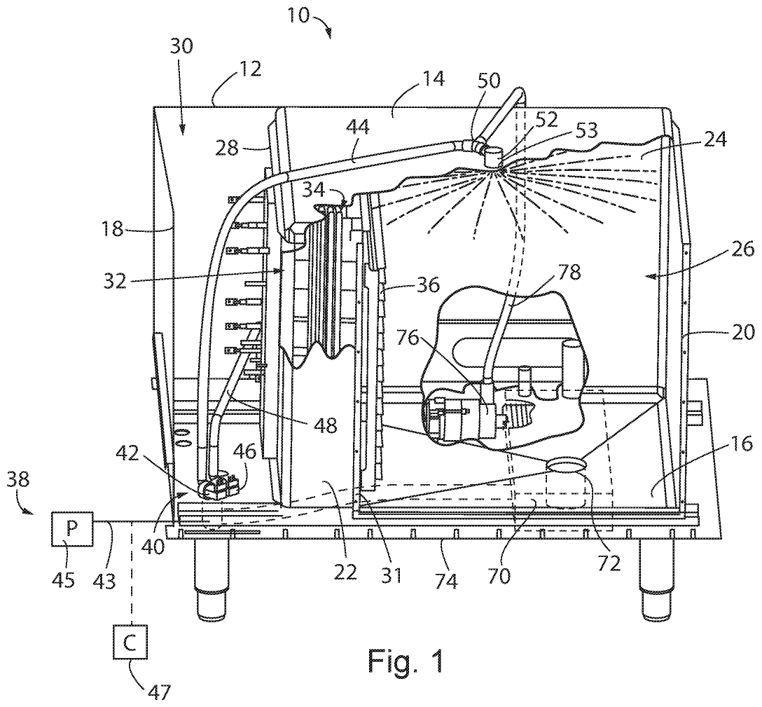

Referring initially to FIG. 1, a cooking oven 10 includes a cleaning system according to the present invention. The cooking oven 10 may be, for example, a combination oven. The cooking oven 10 includes a housing 12 having upper and lower walls 14 and 16, respectively, opposing left and right sidewalls 18 and 20, respectively, and opposing front and rear walls 22 and 24, respectively.

A cooking chamber 26 held within the housing 12 is defined by the upper and lower walls 14 and 16, right sidewall 20, and a left chamber sidewall 28 spaced inwardly from, and extending parallel to, the left sidewall 18. A front door assembly (not shown) is carried by the front wall 22, and optionally, a rear door assembly (not shown) is carried by the rear wall 24, that can be opened and closed to provide access to the cooking chamber 26 through an opening in an open position and sealable over the opening of the cooking chamber 26 in a closed position.

The left sidewall 18 and the left chamber sidewall 28 define the lateral boundaries of an electronics cabinet 30 also held within the housing 12 adjacent to the cooking chamber 26 that contains control components (e.g., a microprocessor, not shown, or other suitable controller) of the cooking oven 10, such as a controller 47 of a cleaning assembly 38 further described below. The electronics cabinet 30 may alternatively be held within the housing 12 above or below the cooking chamber 26 of the cooking oven 10 or in any orientation within the housing 12 with respect to the cooking chamber 26 of the cooking oven 10 that allows for electronic communication with the cooking chamber 26. In particular, the electronics cabinet 30 houses a control assembly that controls various aspects of the cooking oven 10, such as temperature control, cooking sequences, and cleaning functions. The electronics cabinet 30 further houses a part of a cleaning assembly 38 receiving fresh water and/or cleaning solution and delivering the fresh water and/or cleaning solution to the cooking chamber 26 as further described below. Oven operation is controlled by an operator via a set of user controls and outputs that are disposed on the front wall 22 of the electronics cabinet 30 in conjunction with various programs, such as a cleaning program, stored in memory.

The cooking chamber 26 may include a heating compartment 32 on a left side of the cooking chamber 26 with the left chamber sidewall 28 and a dividing wall 31, spaced inwardly from, and extending parallel to the left chamber sidewall 28, defining the lateral boundaries of the heating compartment 32. The heating compartment 32 may carry a heating assembly 34 capable to prepare food product using radiant, heat, convection, and/or steam heating. The heating assembly 34 may include a radial fan with blades that rotate around a hub, a fan motor, a heating element looped around the fan blades of the radial fan, and a water atomizer disposed proximal to the hub of the radial fan. The heating element may be a resistive coil. The heating assembly 34 may provide radiant, heat, convection, and/or steam heating as described in US patent application publication no. 2008/0223357, U.S. Pat. Nos. 7,157,668, and 6,188,045, assigned to the assignee of the present invention and each of which are hereby incorporated by reference. Alternatively, heating assembly 34 may include a gas burner with gas heat exchange tubes to supply the necessary heat for cooking. Alternatively, the cooking oven 10 may include a radiant heat assembly, a smoker assembly, and/or a rotisserie assembly.

The dividing wall 31 may include a plurality of venting holes that allow steam and heated air to flow from the heating compartment 32 into the cooking chamber 26. The dividing wall 31 may also include a grill that is axially aligned with the fan hub to provide an air intake for the fan.

A rack support 36 may be attached to the dividing wall 31 and include rack shelves (removed) that project from the dividing wall 31 to support cooking racks and trays placed within the cooking chamber 26. A corresponding rack support 36 may also be attached to the opposed right sidewall 20.

The cooking oven 10 may provide a cleaning assembly 38 that cleans the cooking chamber 26. The cleaning assembly 38 may include a water valve 42 that is connected to a fresh water inlet line 43 that supplies pressurized clean water. A pump 45 can be used to increase the water pressure in the water inlet line 43. Fresh water inlet valve 40 may be a double solenoid valve including a first valve 42 connected to a spray hose 44 and a second valve 46 connected to a cooling hose 48. The fresh water inlet valve 40 may be electrically connected to the controller 47 as further described below. Alternately, first valve 42 and second valve 46 may be separate single solenoid valves.

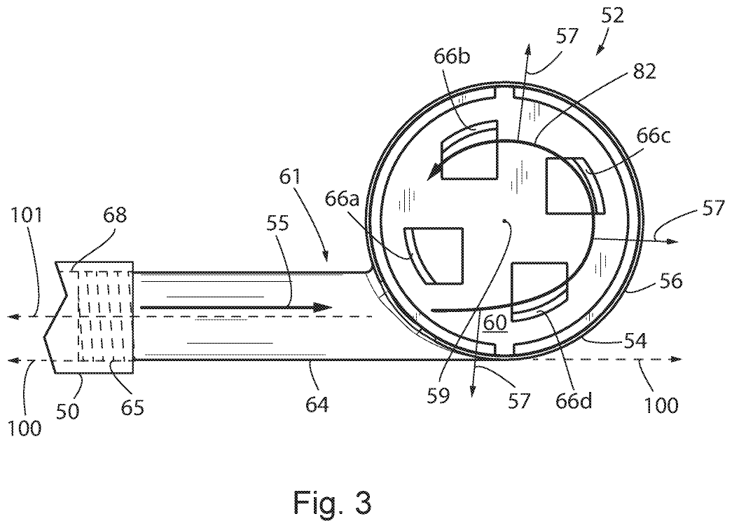

Optionally, the spray hose 44 leads to and is connected to a connector 50 that is connected to, or forms part of, a nozzle 52. The connector 50 may be a y-connector providing connection of more than one water source. The connector 50 may be connected to the nozzle 52 through a threaded collar 65 engaging with a corresponding threaded collar 68 of the connector 50 (see FIG. 3). In some embodiments, the connector 50 or y-connector may not be needed, for example, when the liquid comes directly from one water source or pump only.

The nozzle 52 extends above the cooking chamber 26 along the upper wall 14 and downward through an opening 53 in the upper wall 14 that is generally centrally located. The upper wall 14 may be further covered by an upper exterior wall (not shown) covering the upper wall 14, spray hose 44, and nozzle 52 from an exterior environment. The nozzle 52 disperses a spray of liquid into the cooking chamber 26, as further described below.

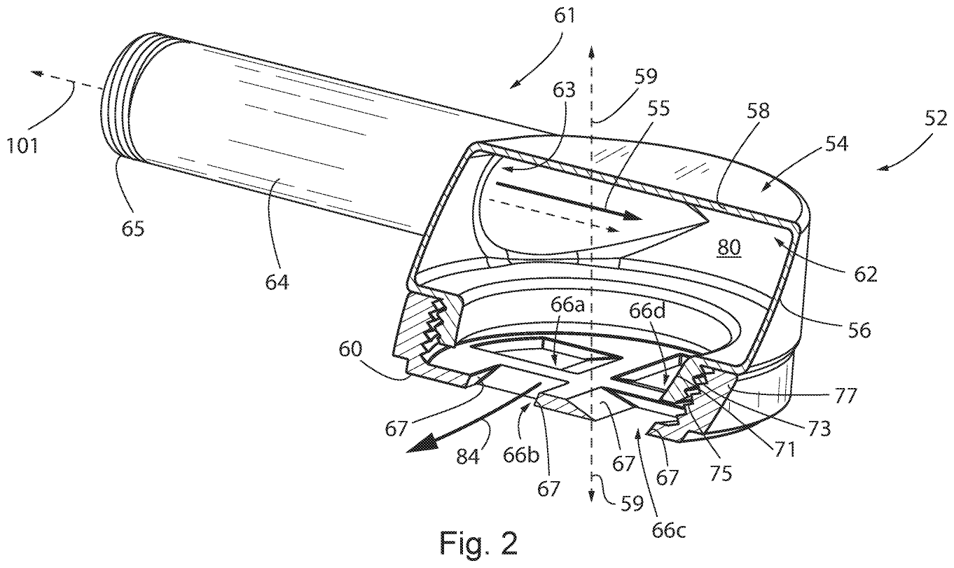

Referring now to FIGS. 2 through 3, the nozzle 52 may be defined by a nozzle chamber 54 receiving the liquid from a circulatory pump 76 as further described below. The nozzle chamber 54 may have a curved diverter wall 56 enclosed at a top edge by a circular top wall 58 and at a bottom edge by a circular bottom wall 60 to define a chamber volume 62. The curved diverter wall 56 may be circular or otherwise form a cylindrical shape. The top wall 58 and bottom wall 60 may be substantially planar.

The bottom wall 60 may be removable from the curved diverter wall 56 to provide access to the chamber volume 62, for example, for clearing the chamber volume 62 of debris. Alternatively, the bottom wall 60 may be fixed to the curved diverter wall 56 without being removeable. A diameter of the curved diverter wall 56 at a bottom edge may be reduced to provide a downwardly extending vertical rim wall 71 with outer screw threads 73 for mating attachment to inner screw threads 75 of an upwardly extending vertical rim wall 77 of the bottom wall 60. In this respect, the outer perimeter of the bottom wall 60 may provide the upwardly extending vertical rim wall 77 and the bottom wall 60 may be rotated with respect to the curved diverter wall 56 to attach or detach the bottom wall 60 to and from the curved diverter wall 56. It is understood that other mating attachment method may be used between the bottom wall 60 and the curved diverter wall 56 such as a gasket providing a friction fit between the vertical rim wall 71 of the curved diverter wall 56 and the vertical rim wall 77 of the bottom wall 60.

The curved diverter wall 56 of the nozzle chamber 54 may include a side inlet 61 allowing for a straight flow path 55 of liquid to flow horizontally through the side inlet 61 to meet the curved diverter wall 56 along an axis 100 tangent to the curved diverter wall 56 (see FIG. 3). In this respect, the side inlet may extend horizontally along an inlet centerline 101 which is offset from a vertical center axis 59 of the nozzle chamber 54, and therefore, is oriented toward one side of the nozzle chamber 54 (as opposed to the inlet centerline 101 passing through the vertical center axis 59). A diameter of the side inlet 61 may be less than a radius of the curved diverter wall 56 and may extend between the curved diverter wall 56 and the vertical center axis 59 of the nozzle chamber 54.

The side inlet 61 may be defined by a hollow tube 64 having an internal passage 63 permitting the liquid to pass from the connector 50 into the nozzle chamber 54. The liquid may flow out of the side inlet 61 in the straight flow path 55 but may quickly contact a smooth, inner surface 80 of the curved diverter wall 56 such the straight flow path 55 of the liquid changes into circular flow 82, conserving the kinetic energy of the liquid while minimizing turbulence. The circular flow 82 is acted upon by a centrifugal force 57 extending from the center of the nozzle chamber 54 outward toward the curved diverter wall 56 to retain the circular flow 82 substantially against the smooth, inner surface 80.

The bottom wall 60 of the nozzle chamber 54 may carry a plurality of outlets or exit ports 66 extending generally perpendicular to the axis 100, and through which sub streams of the liquid are dispersed from the chamber volume 62 downward and tangentially to the curved diverter wall 56. The exit ports 66 may be a plurality of generally rectangular slots positioned in the bottom wall 60 between the center axis 59 to an outer edge of the bottom wall 60, and allowing liquid to pass from the chamber volume 62 outward at various downward angles. For example, the exit ports 66 may include four slots 66a, 66b, 66c, 66d that extend radially from the center axis 59 of the curved diverter wall 56 and meeting the curved diverter wall 56 in four orthogonal directions in a “pinwheel” formation as shown in FIG. 3.

As seen in FIG. 2, the exit ports 66 may include outwardly canted sidewalls 67 sloping outward from the center axis 59 to direct the liquid radially outward, away from the center axis 59 of the nozzle chamber 54. For example, the exit ports 66 may be sectors of a circle equally spaced about the center axis 59 of the curved diverter wall 56 and are canted from vertical along canted axes parallel to tangents of the curved diverter wall 56.

The exit ports 66 may have an outer dimension that is greater than a diameter of the side inlet 61. In this respect, the large dimension exit ports 66 prevent food debris from being clogged within the exit ports 66.

Referring again to FIG. 1, fresh water is sprayed out of the nozzle 52 when the first valve 42 is actuated by the controller 47, communicating with the first valve 42 to allow water flow through the first valve 42 to clean the cooking chamber 26. Other embodiments may include more than one nozzle 52 spraying fresh water into the cooking chamber 26.

The controller 47 may provide for a processor communicating with the first valve 42 and pump 45 and executing a program stored in memory to implement cleaning control of the cooking oven 10. For example, the cooking oven 10 may be programmed to initiate cleaning operation at the end of a cooking cycle, at the end of a predetermined number of cooking cycles, or when prompted by user outputs.

A cooling hose 48 may lead from the fresh water inlet line 43 to a tank 70 receiving the drained liquids from the cooking chamber 26. The tank 70 may be mounted underneath the cooking chamber 26 and is configured to allow for liquids to drain from the cooking chamber 26. A drain 72 extends from a drain opening in the lower wall 16 of cooking chamber 26 to the tank 70. The drain 72 also extends through an opening in a bottom exterior wall 74 to the tank 70. The lower wall 16 may be slanted towards the drain 72 to facilitate draining.

The cooling hose 48 is connected from the fresh water inlet line 43 to the tank 70 below a water level. Fresh water is provided to the tank 70 when the second valve 46 is actuated by the controller 47. The fresh water coming from the cooling hose 48 can help cool the liquid in tank 70 before the liquid exits the tank 70.

Therefore, fresh water can be introduced into the tank 70 directly through cooling hose 48 and/or indirectly from the cooking chamber 26 through spray hose 44 and nozzle 52.

A circulatory pump 76 may be connected to the tank 70. A circulatory hose 78 is connected between the circulator pump 76 and the connector 50. The circulatory pump 76 pumps liquid from the tank 70 back to the spray nozzle 52, which then disperses the re-circulated liquid into the cooking chamber 26. This liquid can then drain back into the tank 70 and be re-circulated again by pump 76. The circulator pump 76 may communicate with and be electrically connected to the controller 47.

In an alternative embodiment, liquid may flow from the circulatory pump 78 only and no fresh water may be introduced through first valve 42 and spray hose 44. In this respect, all fresh water is pumped from or through tank 70 and flows through circulatory hose 78 for better energy efficiency.

In operation of the present invention described above, the controller 47 of the cooking oven 10 may communicate with a memory holding a stored program executed by the controller 47 for control of the first valve 42 and the pump 45. For example, at the end of the cooking cycle, the controller 47 may actuate the first valve 42 and the pump 45 to provide pressurized liquid to flow through the spray hose 44, and actuation of the circulatory pump 76 provides pressurized liquid to flow along the straight flow path 55 through the circulatory hose 78, through the connector 50, and into the nozzle chamber 54.

As liquid flows along straight flow path 55 through the side inlet 61 and along the curved diverter wall 56 of the nozzle chamber 54, liquid meets the smooth, inner surface 80 of the curved diverter wall 56 to conserve the kinetic energy of the straight flow 55 liquid entering the nozzle chamber 54 as it converts to the circular flow 82. The circular flow 82 has a tangential velocity perpendicular to the centrifugal force 57.

As the liquid moves along the circular flow path 82 in a circular swirling motion along the smooth, inner surface 80 of the curved diverter wall 56, gravitational forces also move the liquid downward toward the bottom wall 60. As the liquid moves downward, the liquid contacts the sidewalls 67 of the exit ports 66 causing the liquid to leave the nozzle chamber 54 along canted flow paths 84 retaining the tangential velocity of the swirling liquid so that the liquid is expelled at high angled forces toward the lower wall 16 and the four sidewalls 18, 20, 22, 24 of the cooking chamber 26. In this respect, the high velocity liquid may better contact an upper portion of the four sidewalls 18, 20, 22, 24 for cleaning.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference, which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

We claim:

1. A cooking oven comprising:
an oven housing providing a cooking cavity having sidewalls flanking a cooking volume, the cooking volume accessible through an oven door when the oven door is in an open position and sealed by the oven door when the oven door is in a closed position;
a heater communicating with the cooking cavity to heat air of the cooking cavity; and
a nozzle having an inlet for receiving a stream of water and providing a curved diverter wall for directing the stream of water to multiple outlets providing sub streams in different directions.

2. The cooking oven of claim 1 wherein the stream meets the curved diverter wall along a tangent of the curved diverter wall.

3. The cooking oven of claim 1 wherein the stream of water is directed horizontally and the curved diverter wall curves in a horizontal plane.

4. The cooking oven of claim 1 wherein the curved diverter wall abuts a bottom wall providing openings directing sub streams of water downward and tangentially to the curved diverter wall.

5. The cooking oven of claim 1 wherein the curved diverter wall is substantially circular.

6. The cooking oven of claim 1 wherein the outlets are slots extending radially from an axis of the curved diverter wall.

7. The cooking oven of claim 1 wherein the outlets are in a horizontal plane below the curved diverter wall.

8. The cooking oven of claim 1 wherein the multiple outlets comprise of four outlets.

9. The cooking oven of claim 1 wherein the multiple outlets provide sub streams in orthogonal directions.

10. The cooking oven of claim 1 wherein the inlet further comprises a cylindrical tube extending into the nozzle.

11. The cooking oven of claim 1 wherein the inlet opens into the nozzle along a tangent of the curved diverter wall.

12. The cooking oven of claim 1 further comprising a hose extending between a fresh water source and the nozzle.

13. The cooking oven of claim 12 wherein the hose extends along a ceiling of the cooking cavity and the nozzle is positioned substantially centered within a ceiling of the cooking cavity.

14. A method of cleaning a cooking oven of a type having:
an oven housing providing a cooking cavity having sidewalls flanking a cooking volume, the cooking volume accessible through an oven door when the oven door is in an open position and sealed by the oven door when the oven door is in a closed position;
a heater communicating with the cooking cavity to heat air of the cooking cavity;
a nozzle having an inlet for receiving a stream of water and providing a curved diverter wall for directing the stream of water to multiple outlets providing sub streams in different directions;
an inlet valve receiving water from a source of pressurized water and communicating water to the nozzle; and
an electronic computer communicating with the liquid inlet valve, the method comprising the steps of executing a stored program on the electronic computer to:
actuate the inlet valve so provide pressurized water flow into the nozzle for a cleaning operation.
